(19) United States
(12) Patent Application Publication
(10) Pub. No.: US 2003/0123766 A1
(43) Pub. Date: Jul. 3, 2003

(54) Dustproof and oil leakproof structure of bearing

(75) Inventors: Alex Horng, Kaohsiung City (TW); Ching-Shen Hong, Kaohsiung (TW)

Correspondence Address: Bacon & Thomas, 625 Slaters Lane-4th Floor, Alexandria, VA, 22314, US

(73) Assignee: Sunonwealth Electric Machine Industry Co., Ltd., Kaohsiung (TW)

(21) Appl. No.: 10/028,763

(22) Filed: Dec. 28, 2001

(51) Int. Cl. F16C 33/74

(52) U.S. Cl. 384/130

(57) ABSTRACT

A dustproof and oil leakproof structure of a bearing includes a shaft seat having a bearing provided therein, and a rotation shaft rotatably mounted in the bearing. The characteristic is in that, a race is formed with a hole that is closely combined on the rotation shaft located above the bearing, and a circumferential edge of the race is in almost or slightly contact with the inner wall of the shaft seat.

### BACKGROUND OF THE INVENTION

1. Field of the Invention

The present invention relates to a dustproof and oil leakproof structure of a bearing, wherein a race is closely combined on the rotation shaft of the bearing so that the bearing may have a better dustproof and oil leakproof effect.

2. Description of the Related Art

As shown in FIG. 7, the prior art aware of applicant comprises a housing body 91, and a fan blade member 92. The hub of the fan blade member 92 has a rotation shaft axially protruded with an oil stop cylinder 94 which encloses the top section of the rotation shaft. The bottom of the oil stop cylinder 94 is rested on the shaft seat 95, and is enclosed by the top end edge of the shaft seat 95. Thus, when the fan blade member 92 is driven to rotate, the lubricating oil between the rotation shaft 93 and the bearing 96 sputtering upward and outward along the rotation shaft 93 due to the action of the centrifugal force may be stopped by the oil stop cylinder 94, and may be introduced to flow back between the rotation shaft 93 and the bearing 96.

### SUMMARY OF THE INVENTION

The primary objective of the present invention is to provide a dustproof and oil leakproof structure of a bearing, wherein a race is closely combined on the rotation shaft of the bearing so that the bearing may have a better dustproof and oil leakproof effect.

In accordance with the present invention, there is provided a dustproof and oil leakproof structure of a bearing including a shaft seat having a bearing provided therein, and a rotation shaft rotatably mounted in the bearing.

The characteristic is in that, a race is formed with a hole that is closely combined on the rotation shaft located above the bearing, and a circumferential edge of the race is in almost or slightly contact with the inner wall of the shaft seat.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a dustproof and oil leakproof structure of a bearing in accordance with a first embodiment of the present invention;

FIG. 2 is a front plan cross-sectional assembly view of the dustproof and oil leakproof structure of a bearing as shown in FIG. 1;

FIG. 3 is a locally enlarged view of the dustproof and oil leakproof structure of a bearing taken along circle 3 as shown in FIG. 2;

FIG. 4 is a front plan cross-sectional view of a race of the dustproof and oil leakproof structure of a bearing in accordance with the second embodiment of the present invention;

FIG. 5 is a front plan cross-sectional view of a race of the dustproof and oil leakproof structure of a bearing in accordance with the third embodiment of the present invention;

FIG. 6 is a front plan cross-sectional view of a race of the dustproof and oil leakproof structure of a bearing in accordance with the fourth embodiment of the present invention; and

FIG. 7 is a cross-sectional assembly view of a conventional structure in accordance with the prior art.

### DETAILED DESCRIPTION OF THE PREFERRED EMBODIMENTS

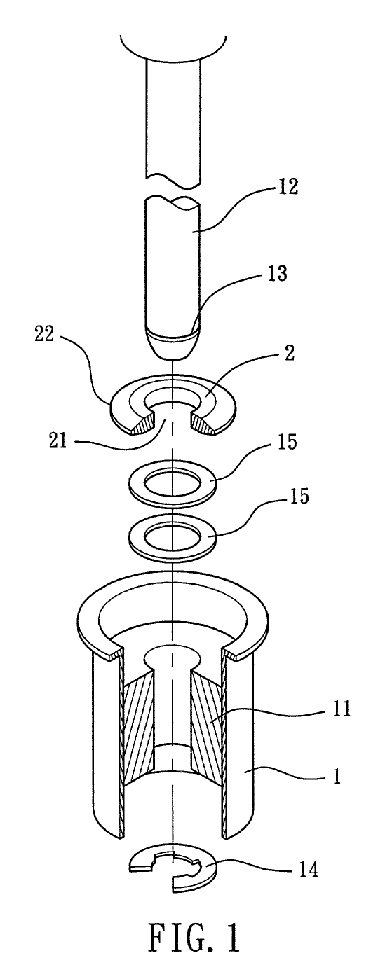

Referring to the drawings and initially to FIG. 1, a dustproof and oil leakproof structure of a bearing in accordance with a first embodiment of the present invention comprises a shaft seat 1 having a bearing 11 provided therein. the shaft seat 1 may be a shaft tube, shaft cylinder or the like of a conventional heatsink fan housing. The bearing 11 may be a conventional ball bearing, oil-impregnated bearing or the like. The rotation shaft 12 of a rotor may be rotatably mounted in the bearing 11. The rotation shaft 12 is formed with an annular groove 13. A snapping member 14, such as a C-shaped snap ring, may be snapped in the annular groove 13, thereby preventing detachment of the rotation shaft 12.

The characteristic features of the present invention are described as follows.

The rotation shaft 12 located above the bearing 11 is fitted with a race 2, and at least one washer 15. The race 2 has a circular shape, and has a central portion formed with a hole 21 which is closely fitted on the rotation shaft 12 to integrally rotate with the rotation shaft 12. The circumferential edge 22 of the race 2 is in almost or slightly contact with the inner wall of the shaft seat 1. Thus, the minimum gap is formed between the circumferential edge 22 of the race 2 and the inner wall of the shaft seat 1. The race 2 is preferably made of a soft material such as a rubber. The thickness of the circumferential edge 22 of the race 2 is smaller than that of the mediate portion of the race 2, and the thickness of the mediate portion of the race 2 is gradually tapered toward the circumferential edge 22 of the race 2. At least one washer 15 is mounted between the race 2 and the bearing 11, thereby preventing the friction from producing between the race 2 and the bearing 11. The washer 15 and the rotation shaft 12 may form a loose fit.

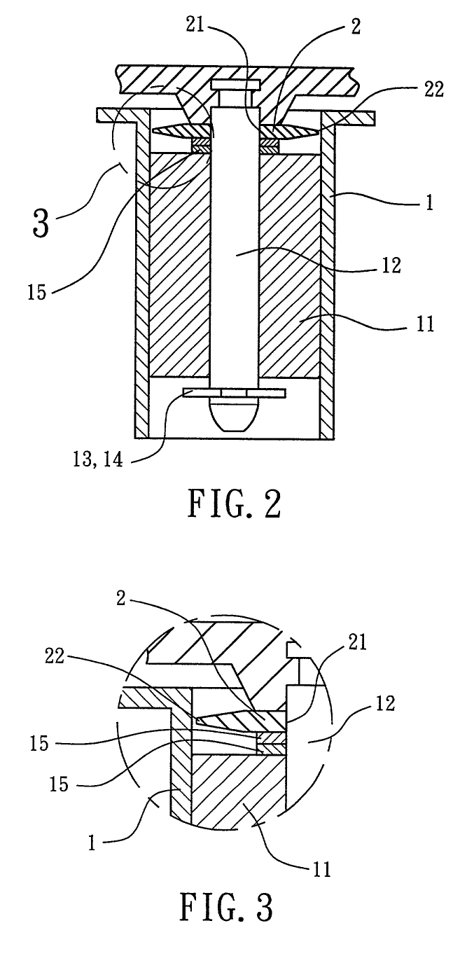

Referring to FIGS. 2 and 3, the race 2 and the washer 15 are combined on the rotation shaft 12 and in the shaft seat 1. The hole 21 of the race 2 is closely combined on the rotation shaft 12, and the circumferential edge 22 of the race 2 is in almost or slightly contact with the inner wall of the shaft seat 1. Thus, the minimum gap is formed between the circumferential edge 22 of the race 2 and the inner wall of the shaft seat 1. Thus, the race 2 may have a better dustproof effect. When the rotation shaft 12 is rotated, the lubricating oil between the rotation shaft 12 and the bearing 11 sputtering upward and outward along the rotation shaft 12 due to the action of the centrifugal force may be stopped by the race 2, and may move downward along the contact face of the bearing 11 and the inner wall of the shaft seat 1 to be recycled. In addition, at least one washer 15 is mounted between the race 2 and the bearing 11, and the washer 15 and the rotation shaft 12 may form a loose fit. Thus, the wear between the race 2 and the bearing 11 may be reduced.

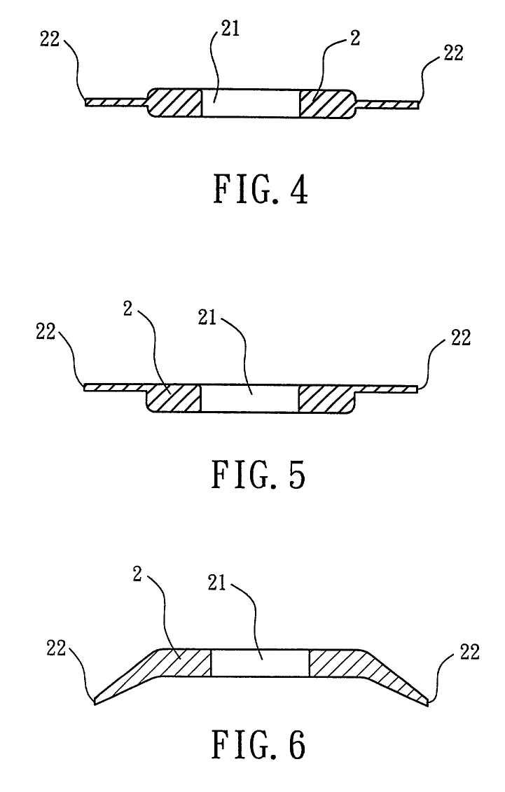

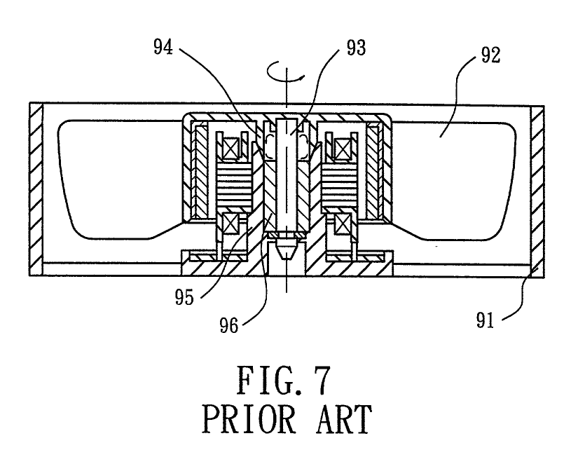

Referring to FIG. 4, the race 2 of the dustproof and oil leakproof structure of a bearing in accordance with a second embodiment of the present invention is shown. The race 2 has a hole 21 and a circumferential edge 22. The mediate portion of the race 2 is thicker, and the circumferential edge 22 of the race 2 is thinner. In the preferred embodiment of the present invention, the thinner portion of the race 2 may form a single thickness, and is mounted on the middle of the thicker portion of the mediate portion of the race 2 in an annular manner. Thus, the race 2 is closely mounted on the rotation shaft 12, thereby providing the same dustproof and oil leakproof effect.

Referring to FIG. 5, the race 2 of the dustproof and oil leakproof structure of a bearing in accordance with a third embodiment of the present invention is shown. The race 2 has a hole 21 and a circumferential edge 22. The mediate portion of the race 2 is thicker, and the circumferential edge 22 of the race 2 is thinner. In the preferred embodiment of the present invention, the thinner portion of the race 2 may form a single thickness, and is mounted on one end face of the thicker portion of the mediate portion of the race 2 in an annular manner. Thus, the race 2 is closely mounted on the rotation shaft 12, thereby providing the same dustproof and oil leakproof effect.

Referring to FIG. 6, the race 2 of the dustproof and oil leakproof structure of a bearing in accordance with a fourth embodiment of the present invention is shown. The race 2 has a hole 21 and a circumferential edge 22. The mediate portion of the race 2 is thicker, and the circumferential edge 22 of the race 2 is thinner. In the preferred embodiment of the present invention, the circumferential edge 22 of the race 2 is extended outward and downward from the periphery of the mediate portion of the race 2. Thus, the race 2 is closely mounted on the rotation shaft 12, thereby providing the same dustproof and oil leakproof effect.

Thus, when the race of the present invention is closely mounted on the rotation shaft, the minimum gap is formed between the circumferential edge of the race and the inner wall of the shaft seat. Thus, the race may prevent the tiny dust particles in the air from entering between the bearing and the rotation shaft, thereby preventing the dust particles from being mixed with the lubricating oil to produce the oil mud, to prevent from hindering operation of the motor. Thus, the race has a better dustproof effect. In addition, when the rotation shaft is rotated, the lubricating oil between the rotation shaft and the bearing sputtering upward and outward along the rotation shaft due to the action of the centrifugal force may be stopped by the race, and may move downward along the contact face of the bearing and the inner wall of the shaft seat to be recycled. Further, at least one washer is mounted between the race and the bearing, to reduce the friction between the race and the bearing. Thus, the wear of the race may be reduced, thereby increasing the lifetime of the race.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A dustproof and oil leakproof structure of a bearing, comprising: a shaft seat having a bearing provided therein, and a rotation shaft rotatably mounted in the bearing, the improvement comprising: a race is formed with a hole closely combined on the rotation shaft located above the bearing, and a circumferential edge of the race is in almost or slightly contact with the inner wall of the shaft seat.

2. The dustproof and oil leakproof structure of a bearing as claimed in claim 1, wherein the rotation shaft has an annular groove for a snapping connection of a snap member.

3. The dustproof and oil leakproof structure of a bearing as claimed in claim 1, further comprising at least one washer mounted on the rotation shaft between the race and the bearing in a loose fit manner.

4. The dustproof and oil leakproof structure of a bearing as claimed in claim 1, wherein the thickness of the circumferential edge of the race is smaller than that of the mediate portion of the race.

5. The dustproof and oil leakproof structure of a bearing as claimed in claim 4, wherein the thickness of the mediate portion of the race is gradually tapered toward the circumferential edge of the race.

6. The dustproof and oil leakproof structure of a bearing as claimed in claim 4, wherein the circumferential edge of the race is formed with the same thickness, and is mounted on the middle of the mediate portion of the race in an annular manner.

7. The dustproof and oil leakproof structure of a bearing as claimed in claim 4, wherein the circumferential edge of the race is formed with the same thickness, and is mounted on an end edge of the mediate portion of the race in an annular manner.
